(19) United States
(12) Patent Application Publication
(10) Pub. No.: US 2025/0033608 A1
(43) Pub. Date: Jan. 30, 2025

(54) PEDAL DEVICE AND METHOD FOR MANUFACTURING PEDAL DEVICE

(71) Applicant: DENSO CORPORATION, Kariya-city (JP)

(72) Inventors: Masashi ARAO, Kariya-city (JP); Etsugo YANAGIDA, Kariya-city (JP); Yuki MATSUNAGA, Kariya-city (JP); Atsushi NISHIMURA, Kariya-city (JP); Kenichiro TAKENAKA, Kariya-city (JP); Makoto SHIGEMATSU, Kariya-city (JP)

(21) Appl. No.: 18/912,832

(22) Filed: Oct. 11, 2024

Related U.S. Application Data
(63) Continuation of application No. PCT/JP2023/014413, filed on Apr. 7, 2023.

(30) Foreign Application Priority Data
Apr. 29, 2022 (JP) 2022-075560

(51) Int. Cl. B60T 7/06; B60T 7/04; G05G 1/38; G05G 1/44; G05G 1/50

(52) U.S. Cl. CPC B60T 7/06; B60T 7/042; G05G 1/38; G05G 1/44; G05G 1/506

(57) ABSTRACT

A pedal device includes a pedal, a rotatable shaft, a cover and a housing main body. The rotatable shaft includes a first projection and a second projection. A first bearing rotatably supports the first projection. A second bearing rotatably supports the second projection. The pedal is supported by the rotatable shaft to enable rotation of the pedal relative to a housing. The cover and the housing main body are fixed relative to each other in an adjusted state where a position of the cover and a position of the housing main body are adjusted such that a radial position of a central axis of the first bearing and a radial position of a central axis of the second bearing coincide with each other.

### CROSS REFERENCE TO RELATED APPLICATIONS

This application is a continuation application of International Patent Application No. PCT/JP2023/014413 filed on Apr. 7, 2023, which designated the U.S. and claims the benefit of priority from Japanese Patent Application No. 2022-075560 filed on Apr. 29, 2022. The entire disclosures of all of the above applications are incorporated herein by reference.

### TECHNICAL FIELD

The present disclosure relates to a pedal device and a method for manufacturing the pedal device.

### BACKGROUND

Previously, there has been proposed a pedal device that includes: a pedal; a housing which rotatably supports the pedal through a rotatable shaft; and a cover. The housing is placed on one side relative to the cover in an axial direction. The axial direction is an extending direction of a central axis of the rotatable shaft. The rotatable shaft has: a one-side projection which projects from the cover toward the one side in the axial direction; and an other-side projection which projects from the housing toward the other side in the axial direction.

The pedal has: a one-side bearing which rotatably supports the one-side projection of the rotatable shaft; and an other-side bearing which rotatably supports the other-side projection of the rotatable shaft.

The housing and the cover are fixed together by snap-fit portions and a labyrinth structure. The labyrinth structure is a structure in which one of a peripheral portion of the housing and a peripheral portion of the cover is fitted and secured to the other one of the peripheral portion of the housing and the peripheral portion of the cover to limit intrusion of a foreign object into a gap between the housing and the cover.

### SUMMARY

According to one aspect of the present disclosure, there is provided a pedal device that includes a pedal, a rotatable shaft, a housing, a first bearing and a second bearing. The housing includes a cover and a housing main body, wherein the housing main body is placed on one side relative to the cover in an axial direction that is an extending direction of the central axis. The rotatable shaft includes a first projection and a second projection. The first projection projects from one of the pedal and the housing main body toward another one of the pedal and the housing main body. The second projection projects from one of the pedal and the cover toward another one of the pedal and the cover. The first projection and the second projection extend in the axial direction. The first bearing is supported by the another one of the pedal and the housing main body and rotatably supports the first projection of the rotatable shaft. The second bearing is supported by the another one of the pedal and the cover and rotatably supports the second projection of the rotatable shaft. The pedal is supported by the rotatable shaft to enable rotation of the pedal relative to the housing. The cover and the housing main body are fixed relative to each other in an adjusted state where a position of the cover and a position of the housing main body are adjusted such that a radial position of a central axis of the first bearing in a radial direction and a radial position of a central axis of the second bearing in the radial direction coincide with each other. The radial direction is a direction perpendicular to the central axis.

According to another aspect, there is provided a method for manufacturing the pedal device. The method includes: assembling the pedal and the housing main body through the first bearing in a manner that implements a state where the first projection is supported by the first bearing; assembling the pedal and the cover through the second bearing in a manner that implements a state where the second projection is supported by the second bearing; adjusting the position of the housing main body and the position of the cover such that the radial position of the central axis of the first bearing in the radial direction and the radial position of the central axis of the second bearing in the radial direction coincide with each other, wherein the radial direction is the direction perpendicular to the central axis; and fixing the housing main body and the cover relative to each other in an adjusted state where the position of the housing main body and the position of the cover are adjusted.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic diagram showing an overall configuration of a brake-by-wire system of a vehicle to which a pedal device of a first embodiment is applied.

FIG. 2 is a perspective view of the pedal device of the first embodiment, indicating a housing main body, a cover and a pedal of the pedal device.

FIG. 3 is an exploded view of the pedal device of the first embodiment, indicating the housing main body, the cover, a rotatable shaft and the pedal of the pedal device.

FIG. 4 is a cross-sectional view of the pedal device of FIG. 2 taken along a plane that is parallel to an up-down direction of the vehicle and includes a pedal central axis, indicating the housing main body, the cover, the rotatable shaft and the pedal of the pedal device.

FIG. 5 is a partial cross-sectional view to help explain a process of coinciding radial positions of axes of two bearings of the first embodiment of FIG. 2, indicating a clearance between a bolt and a through-hole forming portion.

FIG. 6 is a flowchart showing respective manufacturing processes of the pedal device of the first embodiment of FIG. 2.

FIG. 7 is a perspective view of the pedal device of a second embodiment, indicating the housing main body and the cover of the pedal device.

FIG. 8 is a partial cross-sectional view taken along line VIII-VIII in FIG. 7 to help explain welding between the housing main body and the cover.

FIG. 9 is a perspective view of the pedal device of a third embodiment, indicating the housing main body and split cover portions of the pedal device.

FIG. 10 is a cross-sectional view of the pedal device of FIG. 9 taken along the plane that is parallel to the up-down direction of the vehicle and includes the pedal central axis, indicating the housing main body, the split cover portions, the rotatable shaft and the pedal of the pedal device.

FIG. 11 is a cross-sectional view to help explain a process of coinciding radial positions of axes of two bearings according to the third embodiment of FIG. 10, indicating a clearance between a bolt and a through-hole forming portion.

FIG. 12 is a partial cross-sectional view showing a fastener member for fixing between the housing main body and the cover according to a fourth embodiment to help explain a clearance between the fastener member and the through-hole forming portion.

FIG. 13 is a perspective view of the pedal device of another embodiment, indicating the cover member, the housing main body and the cover of the pedal device.

FIG. 14 is a cross-sectional view of the pedal device of FIG. 13 taken along the plane that is parallel to the up-down direction of the vehicle and includes the pedal central axis, indicating the cover member, the housing main body and the cover of the pedal device.

FIG. 15 is a cross-sectional view, which corresponds to FIG. 14 and shows the pedal device of another embodiment, indicating the pedal arm, the housing main body, the cover, the rotatable shaft and the bearings of the pedal device.

FIG. 16 is a cross-sectional view, which corresponds to FIG. 14 and shows the pedal device of another embodiment, indicating the pedal arm, the housing main body, the cover, the rotatable shaft and the bearings of the pedal device.

FIG. 17 is a cross-sectional view, which corresponds to FIG. 14 and shows the pedal device of another embodiment, indicating the pedal arm, the housing main body, the cover, the rotatable shaft and the bearings of the pedal device.

FIG. 18 is a cross-sectional view, which corresponds to FIG. 14 and shows the pedal device of another embodiment, indicating the pedal arm, the housing main body, the cover, the rotatable shaft and the bearings of the pedal device.

### DETAILED DESCRIPTION

Previously, there has been proposed a pedal device that includes: a pedal; a housing which rotatably supports the pedal through a rotatable shaft; and a cover. The housing is placed on one side relative to the cover in an axial direction. The axial direction is an extending direction of a central axis of the rotatable shaft. The rotatable shaft has: a one-side projection which projects from the cover toward the one side in the axial direction; and an other-side projection which projects from the housing toward the other side in the axial direction.

The pedal has: a one-side bearing which rotatably supports the one-side projection of the rotatable shaft; and an other-side bearing which rotatably supports the other-side projection of the rotatable shaft.

The housing and the cover are fixed together by snap-fit portions and a labyrinth structure. The labyrinth structure is a structure in which one of a peripheral portion of the housing and a peripheral portion of the cover is fitted and secured to the other one of the peripheral portion of the housing and the peripheral portion of the cover to limit intrusion of a foreign object into a gap between the housing and the cover.

In the pedal device described above, the one-side projection of the rotatable shaft is rotatably supported by the one-side bearing of the pedal, and the other-side projection of the rotatable shaft is rotatably supported by the other-side bearing of the pedal.

However, as discussed above, the housing and the cover are fixed together by the snap-fit portions and the labyrinth structure. Therefore, a positional relationship between the housing and the cover is limited by the snap-fit portions and the labyrinth structure.

Thus, a central axis of the one-side projection of the rotatable shaft and a central axis of the other-side projection of the rotatable shaft may possibly deviate from each other in a radial direction by the amount of dimensional tolerance in some cases. Here, the radial direction is a direction that is perpendicular to the axial direction of the rotatable shaft. Hereinafter, the amount of radial deviation between the central axis of the one-side projection of the rotatable shaft and the central axis of the other-side projection of the rotatable shaft will be referred to as the amount of central axis deviation of the rotatable shaft.

According to the study of the inventors of the present application, it is found that in order to rotate the pedal smoothly, a clearance between the one-side projection of the rotatable shaft and the one-side bearing of the pedal must be made larger than the amount of central axis deviation of the rotatable shaft discussed above.

Furthermore, in order to rotate the pedal smoothly, a clearance between the other-side projection of the rotatable shaft and the other-side bearing of the pedal must be made larger than the amount of central axis deviation of the rotatable shaft discussed above.

However, when the clearance between the one-side projection of the rotatable shaft and the one-side bearing of the pedal is increased, the pedal may not be rotated smoothly. Also, when the clearance between the other-side projection of the rotatable shaft and the other-side bearing of the pedal is increased, the pedal may not be rotated smoothly.

According to one aspect of the present disclosure, there is provided a pedal device including:
a pedal that is configured to be depressed by an operator;
a rotatable shaft that has a central axis;
a housing that includes a cover and a housing main body, wherein the housing main body is placed on one side relative to the cover in an axial direction that is an extending direction of the central axis;
a first bearing; and
a second bearing, wherein:
the rotatable shaft includes:
   a first projection that projects from one of the pedal and the housing main body toward another one of the pedal and the housing main body; and
   a second projection that projects from one of the pedal and the cover toward another one of the pedal and the cover, wherein the first projection and the second projection extend in the axial direction;
the first bearing is supported by the another one of the pedal and the housing main body and rotatably supports the first projection of the rotatable shaft;
the second bearing is supported by the another one of the pedal and the cover and rotatably supports the second projection of the rotatable shaft;
the pedal is supported by the rotatable shaft to enable rotation of the pedal relative to the housing; and
the cover and the housing main body are fixed relative to each other in an adjusted state where a position of the cover and a position of the housing main body are adjusted such that a radial position of a central axis of the first bearing in a radial direction and a radial position of a central axis of the second bearing in the radial direction coincide with each other, wherein the radial direction is a direction perpendicular to the central axis.

Therefore, the radial position of the central axis of the first bearing and the radial position of the central axis of the second bearing can coincide with each other. Thus, the central axis of the first projection of the rotatable shaft and the central axis of the second projection of the rotatable shaft can be appropriately positioned. As a result, it is possible to provide the pedal device, which allows the pedal to rotate smoothly.

According to another aspect of the present disclosure, there is provided a method for manufacturing a pedal device that includes:
a pedal that is configured to be depressed by an operator;
a rotatable shaft that has a central axis;
a housing that includes a cover and a housing main body, wherein the housing main body is placed on one side relative to the cover in an axial direction that is an extending direction of the central axis;
a first bearing; and
a second bearing, wherein:
the rotatable shaft includes:
   a first projection that projects from one of the pedal and the housing main body toward another one of the pedal and the housing main body; and
   a second projection that projects from one of the pedal and the cover toward another one of the pedal and the cover, wherein the first projection and the second projection extend in the axial direction;
the first bearing is supported by the another one of the pedal and the housing main body and rotatably supports the first projection of the rotatable shaft;
the second bearing is supported by the another one of the pedal and the cover and rotatably supports the second projection of the rotatable shaft;
the pedal is supported by the rotatable shaft to enable rotation of the pedal relative to the housing, the method including:
assembling the pedal and the housing main body through the first bearing in a manner that implements a state where the first projection is supported by the first bearing;
assembling the pedal and the cover through the second bearing in a manner that implements a state where the second projection is supported by the second bearing;
adjusting a position of the housing main body and a position of the cover such that a radial position of a central axis of the first bearing in a radial direction and a radial position of a central axis of the second bearing in the radial direction coincide with each other, wherein the radial direction is a direction perpendicular to the central axis; and
fixing the housing main body and the cover relative to each other in an adjusted state where the position of the housing main body and the position of the cover are adjusted.

Therefore, the radial position of the central axis of the first bearing and the radial position of the central axis of the second bearing can coincide with each other. Thus, the central axis of the first projection of the rotatable shaft and the central axis of the second projection of the rotatable shaft can be appropriately positioned. As a result, it is possible to provide the method for manufacturing the pedal device, which allows the pedal to rotate smoothly.

Hereinafter, embodiments of the present disclosure will be described with reference to the drawings. For the sake of simplicity of explanation, the same reference signs are assigned to the portions that are the same or equal to each other in the following respective embodiments.

### First Embodiment

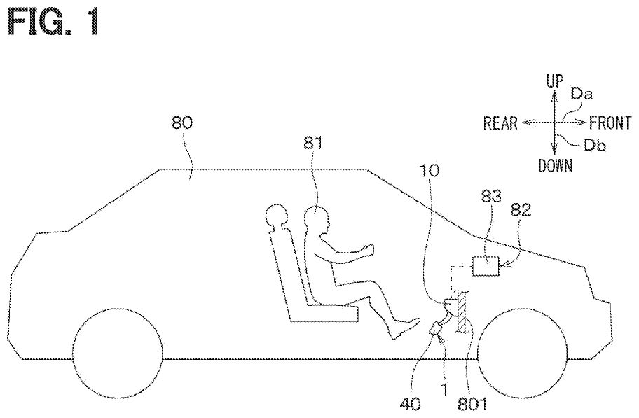

As shown in FIG. 1, a pedal device 1 of the present embodiment is a device installed on an automobile (vehicle) 80 and is depressed by a depression force applied by a human driver 81 (an operator) of the automobile 80. This pedal device 1 is installed on the automobile 80 as a brake pedal device for performing a braking operation of the automobile 80.

Specifically, a brake-by-wire system 82 is installed on the automobile 80 of FIG. 1, and the pedal device 1 is a brake pedal device used in the brake-by-wire system 82. The brake-by-wire system 82 is a system that drives a brake pad of each wheel through a brake circuit by a hydraulic pressure generated by a master cylinder controlled by an electronic controller device 83 installed on the automobile 80 based on an electrical signal outputted from the pedal device 1.

Four arrows shown in FIG. 1 indicate directions of the automobile 80 on which the pedal device 1 is installed.

A vehicle travel direction Da and a vehicle up-down direction Db, which is an up-down direction of the automobile 80 (in other words, the vertical direction of the automobile 80), are indicated by the four arrows. In the description of the present embodiment, a front side in the vehicle travel direction Da is also referred to as a vehicle travel direction front side, and a rear side in the vehicle travel direction Da is also referred to as a vehicle travel direction rear side. The upper side in the vehicle up-down direction Db is also referred to as a vehicle upper side, and the lower side in the vehicle up-down direction Db is also referred to as a vehicle lower side.

As shown in FIGS. 1, 2, 3 and 4, the pedal device 1 includes a housing 10, bearings 20, 30, a pedal 40, a rotational angle sensor 50 and a rotatable shaft 62. The pedal device 1 of the present embodiment is a pendant type pedal device.

The pendant-type pedal device 1 refers to a pedal device configured such that a portion of the pedal 40, which is depressed by the driver 81, is placed on the vehicle lower side (i.e., the lower side in the vertical direction in the state where the pedal device is installed on the vehicle) of a swing center CL of the pedal 40. In the pendant-type pedal device 1, the pedal 40 swings such that the portion of the pedal 40, which is located on the vehicle lower side of the swing center CL, is brought toward the vehicle travel direction front side relative to the swing center CL when the depression force of the driver 81 applied to the pedal 40 is increased.

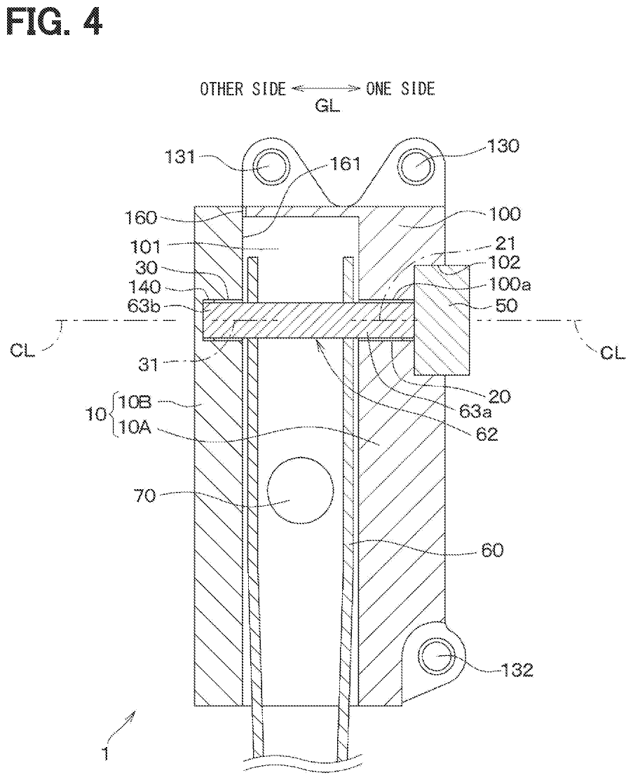

As shown in FIG. 4, the swing center CL of the pedal 40 is a rotational center of the pedal 40 at the time of the swing motion of the pedal 40. Furthermore, in the description of the present embodiment, the swing center CL of the pedal 40 is also referred to as a pedal central axis (i.e., a central axis of the rotatable shaft 62) CL.

The housing 10 includes a housing main body 10A and a cover 10B. The housing main body 10A is placed on one side relative to the cover 10B in an axial direction GL. The axial direction GL is an extending direction of the pedal central axis CL.

The housing main body 10A has a separation wall 100. The separation wall 100 forms housing spaces 101, 102, which serve as inside spaces, at an inner inside of the separation wall 100. The housing main body 10A opens from the housing space 101 toward the other side in the axial direction GL and also toward the vehicle lower side. The housing main body 10A opens from the housing space 102 toward the one side in the axial direction GL.

The housing space 101 is placed on the other side relative to the housing space 102 in the axial direction GL. The separation wall 100 is placed between the housing space 101 and the housing space 102.

The housing main body 10A, together with the cover 10B, is installed on a wall 801, which is an upright wall, of a vehicle body. That is, the housing 10 and the cover 10B form a non-rotatable member that is fixed to the wall 801 of the vehicle body shown in FIG. 1 and does not rotate.

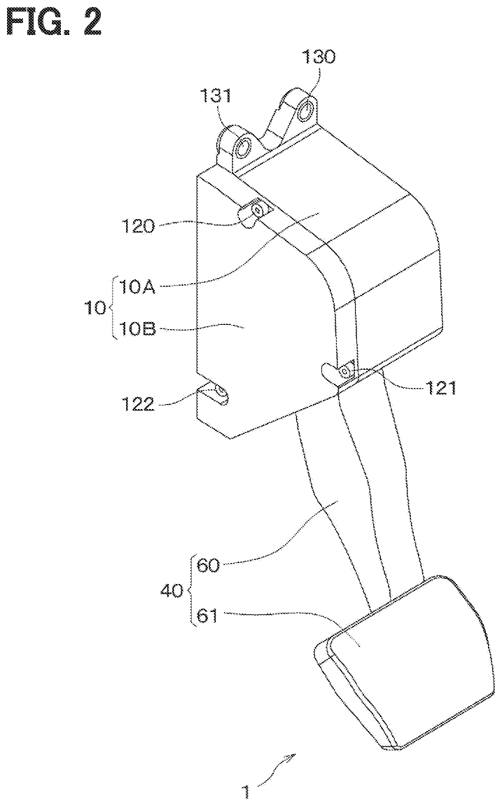

As shown in FIG. 2, the housing main body 10A and the cover 10B are fixed together by a plurality of bolts (serving as fastener components) 120, 121, 122 and are also fixed to the wall 801 of the vehicle body by a plurality of bolts (not shown). The housing main body 10A has a plurality of through-holes 130, 131, 132 through which the bolts for fixing the housing main body 10A to the wall 801 are inserted.

The cover 10B is, for example, a member in a plate form. The cover 10B is arranged to cover the housing space 101 of the housing main body 10A from the other side in the axial direction GL. As shown in FIGS. 2, 3 and 5, the cover 10B has a through-hole forming portion 120b that forms a through-hole 120a through which the bolt 120 is inserted.

The cover 10B has a through-hole forming portion 121b that forms a through-hole 121a through which the bolt 121 is inserted. The cover 10B has a through-hole forming portion 122b that forms a through-hole 122a through which the bolt 122 is inserted.

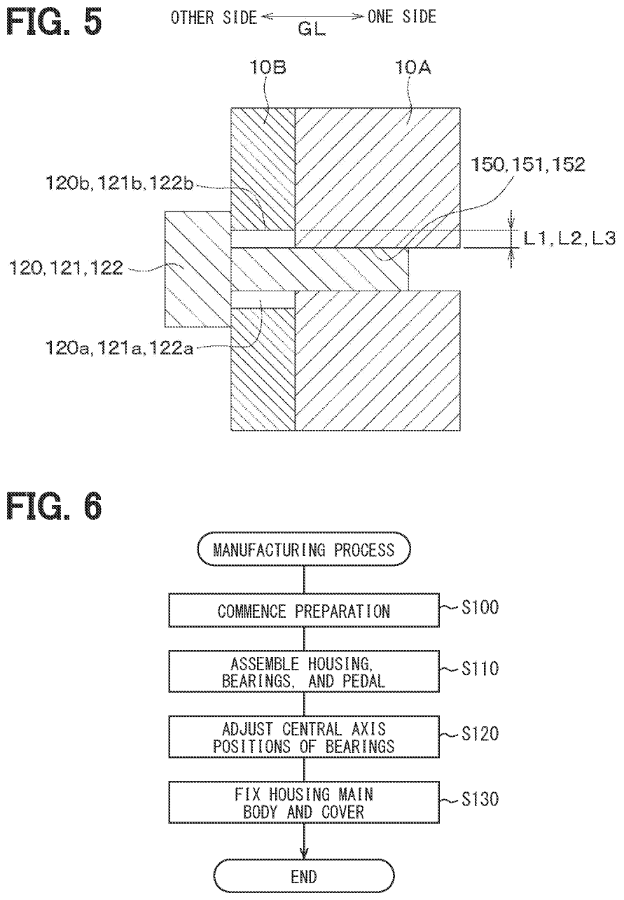

Furthermore, the housing main body 10A has a threaded hole 150 into which the bolt 120 is inserted and tightened, as shown in FIG. 5. The housing main body 10A has a threaded hole 151 into which the bolt 121 is inserted and tightened. The housing main body 10A has a threaded hole 152 into which the bolt 122 is inserted and tightened.

A gap, which is generated between the bolt 120 and the through-hole forming portion 120b in the state where the bolt 120 is inserted through the through-hole 120a of the cover 10B, is defined as a clearance L1. A gap, which is generated between the bolt 121 and the through-hole forming portion 121b in the state where the bolt 121 is inserted through the through-hole 121a of the cover 10B, is defined as a clearance L2. A gap, which is generated between the bolt 122 and the through-hole forming portion 122b in the state where the bolt 122 is inserted through the through-hole 122a of the cover 10B, is defined as a clearance L3.

In the present embodiment, each of the clearances L1, L2, L3 is set so as to enable that a radial position of a central axis 21 of the bearing 20 in a radial direction and a radial position of a central axis 31 of the bearing 30 in the radial direction coincide with each other. The radial direction is a direction that is perpendicular to the swing center CL (i.e., the central axis of the rotatable shaft 62).

The housing main body 10A and the cover 10B are made of, for example, a resin material or a metal material.

As shown in FIG. 4, the housing main body 10A and the cover 10B function as a support body that supports the bearings 20, 30, the pedal 40, the rotational angle sensor 50 and a reaction force generation mechanism 70.

The bearing 20 is supported by the housing main body 10A and is a first bearing that rotatably supports a projection 63a of the rotatable shaft 62 of the pedal 40.

In the present embodiment, for example, a plain bearing, which is shaped in a cylindrical tubular form centered on the pedal central axis CL, is used as the bearing 20. The bearing 20 is fixed in a state where the bearing 20 is press-fitted into a through-hole 100a of the separation wall 100 of the housing main body 10A. The through-hole 100a extends through the separation wall 100 of the housing main body 10A in the axial direction GL. The through-hole 100a extends through the separation wall 100 between the housing spaces 101, 102.

The bearing 30 is supported by the cover 10B and is a second bearing that rotatably supports a projection 63b of the rotatable shaft 62 of the pedal 40. Specifically, the bearing 30 is a plain bearing which is shaped in a cylindrical tubular form centered on the pedal central axis CL.

The bearing 30 is fixed in a state where the bearing 30 is press-fitted into a recess 140 of the cover 10B. The recess 140 is recessed at the cover 10B and opens toward the one side in the axial direction GL. The bearing 30 cooperates with the bearing 20 to rotatably supports the rotatable shaft 62 of the pedal 40.

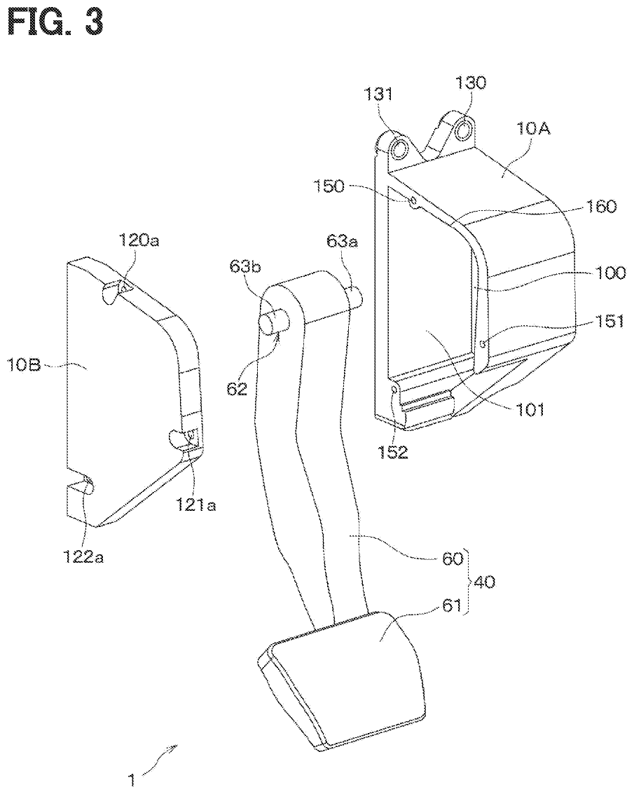

As shown in FIG. 3, the pedal 40 includes a pedal arm 60 and a pedal pad 61. The pedal arm 60 is shaped in a rectangular tubular form that extends from the swing center CL toward the outer side in the radial direction of the swing center CL.

The rotatable shaft 62 is placed at the swing center CL of the pedal arm 60. The rotatable shaft 62 is fixed to the pedal arm 60 in a state where the rotatable shaft 62 extends through the pedal arm 60 in the axial direction GL. In the present embodiment, the rotatable shaft 62 and the pedal arm 60 are made of, for example, a metal material.

Here, the rotatable shaft 62 and the pedal arm 60 are fixed together by, for example, welding. In addition to the welding, another joining method, such as fusing, bonding or the like may be used to fix between the rotatable shaft 62 and the pedal arm 60. As shown in FIG. 4, the rotatable shaft 62 is placed such that the central axis of the rotatable shaft 62 coincides with the pedal central axis CL. The rotatable shaft 62 is formed to extend in the axial direction GL.

Specifically, the rotatable shaft 62 has: the projection (serving as a first projection) 63a, which projects from the pedal arm 60 toward the one side in the axial direction GL; and the projection (serving as a second projection) 63b, which projects from the pedal arm 60 toward the other side in the axial direction GL. The projection 63a is formed to project from the pedal 40 toward the housing main body 10A. The projection 63b is formed to project from the pedal 40 toward the cover 10B.

As shown in FIG. 2, the pedal pad 61 is placed at an outer end portion of the pedal arm 60, which faces the outer side in the radial direction about the swing center CL, and the pedal pad 61 receives the depression force of the driver 81.

As shown in FIG. 4, the rotational angle sensor 50 is placed in the housing space 102 of the housing main body 10A. The rotational angle sensor 50 senses a rotational angle of the rotatable shaft 62 of the pedal 40 and outputs an electrical signal indicating the rotational angle of the rotatable shaft 62 to the electronic controller device 83 of FIG. 1.

The pedal 40 and the rotatable shaft 62 are fixed together to rotate integrally. Therefore, the rotational angle of the rotatable shaft 62 is the same as a rotational angle of the pedal 40. A magnetic sensor circuit using, for example, a Hall element or a magnetoresistive element, or an optical sensor circuit using a rotary encoder may be used as the rotational angle sensor 50.

FIGS. 2, 3, 4 and 5 show the pedal device 1 in a non-depressed state of the pedal 40, i.e., a state where the depression force of the driver 81 is not applied to the pedal 40.

The reaction force generation mechanism 70 generates a reaction force against the depression force which is applied from the driver 81 to the pedal 40. The reaction force generation mechanism includes a plurality of springs and mechanical components and is a reaction force generator that applies a resilient force (i.e., a reaction force), which is based on resilient deformation of the respective springs, to the pedal 40.

The reaction force generation mechanism 70 is supported by the housing 10.

Next, an operation of the pedal device 1 of the present embodiment will be described with reference to FIGS. 1, 2, 3, 4 and 5.

First, when the depression force of the driver 81 is applied to the pedal pad 61 of the pedal 40, the pedal 40 swings around the pedal central axis CL. Specifically, the pedal arm 60, the pedal pad 61 and the rotatable shaft 62 rotate around the pedal central axis CL so that the pedal arm 60 and the pedal pad 61 swing toward the vehicle travel direction front side. In other words, the pedal 40 swings from the non-depressed state to the most depressed state.

At this time, the rotational angle sensor 50 outputs the electrical signal indicating the rotational angle of the rotatable shaft 62 to the electronic controller device 83. The electronic controller device 83 generates a hydraulic pressure (e.g., an oil pressure), which is required to brake the automobile 80 by controlling the operation of the brake circuit of the brake-by-wire system 82 and thereby actuates the brake pads with this hydraulic pressure to decelerate or stop the automobile 80.

Furthermore, during the swing motion of the pedal 40 from the non-depressed state to the most depressed state, when the pedal 40 approaches from the non-depressed state to the most depressed state, the amount of resilient deformation of the respective springs of the reaction force generation mechanism 70 is increased. Therefore, when the pedal 40 approaches the most depressed state from the non-depressed state, the amount of resilient force, which is applied from the reaction force generation mechanism 70 to the pedal 40 toward the other side in the circumferential direction, is increased.

Then, when the application of the depression force of the driver 81 to the pedal 40 is stopped in response to release of the foot of the driver 81 from the pedal 40, the amount of resilient deformation of the respective springs of the reaction force generation mechanism 70 returns it its initial amount.

At this time, in the state where the resilient force of the springs of the reaction force generation mechanism 70 is applied to the pedal 40, the pedal arm 60 and the pedal pad 61 swing around the pedal central axis CL toward the other side in the circumferential direction. In other words, the pedal 40 swings from the most depressed state to the non-depressed state.

Next, a manufacturing method of the pedal device 1 of the present embodiment will be described with reference to FIG. 6.

First, at a preparation process of step S100 shown in FIG. 6, the housing main body 10A, the cover 10B, the bearings 20, 30, the pedal 40 and the rotational angle sensor 50 are separately prepared. In this case, the pedal 40, which is in a state where the rotatable shaft 62 is pre-fixed to the pedal 40, is prepared.

Then, in an assembly process of step S110, the pedal 40 is assembled to the housing main body 10A through the bearing 20 and the projection 63a of the rotatable shaft 62. The pedal 40 is assembled to the cover 10B through the bearing 30 and the projection 63b of the rotatable shaft 62.

For example, the rotatable shaft 62 is assembled to the housing main body 10A and the cover 10B as follows.

The bearing 20 is fixed to the separation wall 100 of the housing main body 10A by press-fitting the bearing 20 into the through-hole 100a of the separation wall 100 of the housing main body 10A. The projection 63a of the rotatable shaft 62 of the pedal 40 is assembled to the housing main body 10A through the bearing 20 by inserting the projection 63a of the rotatable shaft 62 of the pedal 40 through the bearing 20. In this way, the projection 63a of the rotatable shaft 62 of the pedal 40 is supported by the housing main body 10A through the bearing 20.

Furthermore, the bearing 30 is fixed to the recess 140 of the cover 10B by press-fitting the bearing 30 into the recess 140 of the cover 10B. The projection 63b of the rotatable shaft 62 of the pedal 40 is assembled to the cover 10B through the bearing 30 by inserting the projection 63b of the rotatable shaft 62 of the pedal 40 through the bearing 30. In this way, the projection 63b of the rotatable shaft 62 of the pedal 40 is supported by the cover 10B through the bearing 30.

The procedure is not limited to the above-described procedure where the bearing 20 is press-fitted into and is fixed to the housing main body 10A, and then the projection 63a of the rotatable shaft 62 of the pedal 40 is inserted through the bearing 20. The bearing 20 may be press-fitted into and fixed to the housing main body 10A in a state where the projection 63a of the rotatable shaft 62 of the pedal 40 is inserted through the bearing 20.

Furthermore, the procedure is also not limited to the above-described procedure where the bearing 30 is press-fitted into and is fixed to the cover 10B, and then the projection 63b of the rotatable shaft 62 of the pedal 40 is inserted through the bearing 30. That is, the bearing 30 may be press-fitted into and fixed to the cover 10B in a state where the projection 63b of the rotatable shaft 62 is inserted through the bearing 30.

Furthermore, the way of fixing the bearing 20 to the housing main body 10A may be replaced with another way that is other than the press-fitting. Furthermore, the way of fixing the bearing 30 to the cover 10B may be replaced with another way that is other than the press-fitting.

Next, at a position adjustment process of step S120, the positional relationship between the housing main body 10A and the cover 10B is adjusted such that the radial position of the central axis 21 of the bearing 20 and the radial position of the central axis 31 of the bearing 30 coincide with each other.

Specifically, in the state where the bolt 120 is inserted through the through-hole 120a of the cover 10B, the bolt 120 is screwed into the threaded hole 150 of the housing main body 10A to a position where the bolt 120 reaches the middle of the threaded hole 150. Also, in the state where the bolt 121 is inserted through the through-hole 121a of the cover 10B, the bolt 121 is screwed into the threaded hole 151 of the housing main body 10A to a position where the bolt 121 reaches the middle of the threaded hole 151. Furthermore, in the state where the bolt 122 is inserted through the through-hole 122a of the cover 10B, the bolt 122 is screwed into the threaded hole 152 of the housing main body 10A to a position where the bolt 122 reaches the middle of the threaded hole 152.

Next, a positional relationship between the rotatable shaft 62 and the housing main body 10A is adjusted such that a distance between the central axis of the rotatable shaft 62 and the housing main body 10A coincides with a predetermined distance. In addition to this, a positional relationship between the rotatable shaft 62 and the cover 10B is adjusted such that a distance between the central axis of the rotatable shaft 62 and the cover 10B coincides with a predetermined distance. Therefore, a positional relationship between the housing main body 10A and the cover 10B is adjusted through the central axis of the rotatable shaft 62.

At this time, a position of each of the bolts 120, 121, 122 is adjusted in the inside of the corresponding one of the through-holes 120a, 121a, 122a of the cover 10B.

Here, the bearing 20 is fixed to the housing main body 10A. The bearing 30 is fixed to the cover 10B. Therefore, as discussed above, by adjusting the positional relationship between the housing main body 10A and the cover 10B through the central axis of the rotatable shaft 62, the radial position of the central axis 21 of the bearing 20 and the radial position of the central axis 31 of the bearing 30 can coincide with each other.

Next, at a fixation process of step S130, in the state where the bolt 120 is inserted through the through-hole 120a of the cover 10B, the bolt 120 is screwed further into the threaded hole 150 of the housing main body 10A until the bolt 120 reaches its final position. Also, in the state where the bolt 121 is inserted through the through-hole 121a of the cover 10B, the bolt 121 is screwed further into the threaded hole 151 of the housing main body 10A until the bolt 121 reaches its final position. Furthermore, in the state where the bolt 122 is inserted through the through-hole 122a of the cover 10B, the bolt 122 is screwed further into the threaded hole 152 of the housing main body 10A until the bolt 122 reaches its final position.

Therefore, the housing main body 10A and the cover 10B are fixed together by the bolts 120, 121, 122 in the state where the radial position of the central axis 21 of the bearing 20 and the radial position of the central axis 31 of the bearing 30 coincide with each other. Thereby, the manufacturing of the pedal device 1 ends.

In the present embodiment described above, the pedal device 1 includes:
the pedal 40 which is depressed by the driver 81; and the rotatable shaft 62 which is fixed to the pedal 40 and extends in the axial direction GL.

The rotatable shaft 62 has: the projection 63a which projects from the pedal 40 toward the one side in the axial direction GL; and the projection 63b which projects from the pedal 40 toward the other side in the axial direction GL. The projection 63a is formed to project from the pedal 40 toward the housing main body 10A. The projection 63b is formed to project from the pedal 40 toward the cover 10B. The projection 63a and the projection 63b are formed to extend in the axial direction GL. The pedal device 1 further includes: the housing main body 10A; and the cover 10B which is placed on the other side of the housing main body 10A in the axial direction GL.

The pedal device 1 also includes: the bearing 20 which is supported by the housing main body 10A and rotatably supports the projection 63a of the rotatable shaft 62; and the bearing 30 which is supported by the cover 10B and rotatably supports the projection 63b of the rotatable shaft 62. The pedal 40 is supported by the rotatable shaft 62 to enable rotation of the pedal 40 relative to the housing 10.

Therefore, the relative position between the bearing 20 and the bearing 30 can be freely adjusted by adjusting the positional relationship between the cover 10B and the housing main body 10A. Therefore, the cover 10B and the housing main body 10A can be fixed together after the positional relationship between the cover 10B and the housing main body 10A is adjusted to coincide the radial position of the central axis 21 of the bearing 20 and the radial position of the central axis 31 of the bearing 30 with each other.

Thereby, the central axis 21 of the bearing 20 and the central axis 31 of the bearing 30 can coincide with each other. Thus, the central axis of the projection 63a of the rotatable shaft 62 and the central axis of the projection 63b of the rotatable shaft 62 can be appropriately positioned. Thus, it is possible to provide the pedal device 1, which allows the pedal 40 to rotate smoothly, and the method for manufacturing the pedal device 1.

Accordingly, in the present embodiment, the smooth rotation of the rotatable shaft 62 and the pedal 40 can be ensured even when the clearance between the bearing 20 and the rotatable shaft 62 and the clearance between the bearing 30 and the rotatable shaft 62 are small. Thereby, it is possible to limit a deterioration in the measurement accuracy of the rotational angle sensor 50.

Furthermore, as described above, the positional relationship between the housing main body 10A and the cover 10B is adjusted such that the radial position of the central axis 21 of the bearing 20 and the radial position of the central axis 31 of the bearing 30 coincide with each other. This eliminates the need for high dimensional accuracy in the components such as the bearings 20, 30, the rotatable shaft 62, the housing main body 10A, and the cover 10B.

Thus, the manufacturing costs of the components such as the bearings 20, 30, the rotatable shaft 62, the housing main body 10A and the cover 10B can be reduced.

In the present embodiment, the pedal device 1 includes the bolts 120, 121, 122 which fix the housing main body 10A and the cover 10B together. The cover 10B has the through-hole forming portions 120b, 121b, 122b each of which forms the corresponding through-hole 120a, 121a, 122a that extends through the cover 10B in the axial direction GL.

Each clearance L1, L2, L3, which is a gap between the corresponding bolt 120, 121, 122 and the corresponding through-hole forming portion 120b, 121b, 122b, is set so as to enable that the radial position of the central axis 21 of the bearing 20 and the radial position of the central axis 31 of the bearing 30 coincide with each other.

Therefore, the radial position of the central axis 21 of the bearing 20 and the radial position of the central axis 31 of the bearing 30 can easily coincide with each other.

### Second Embodiment

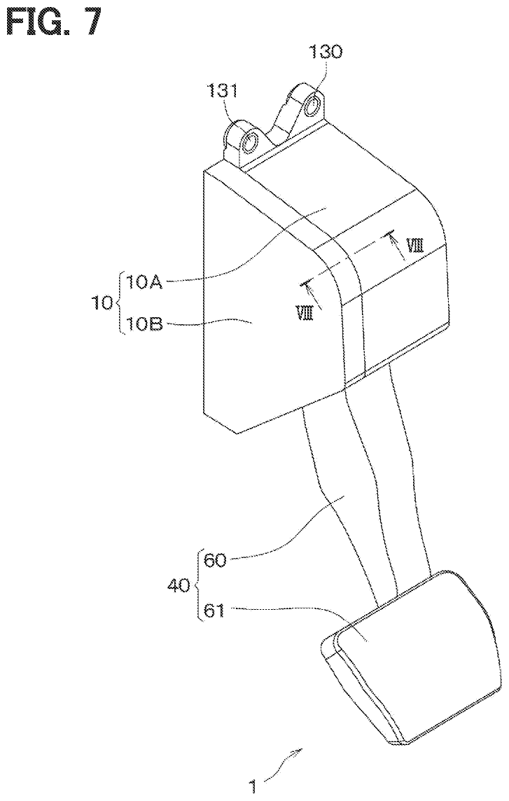

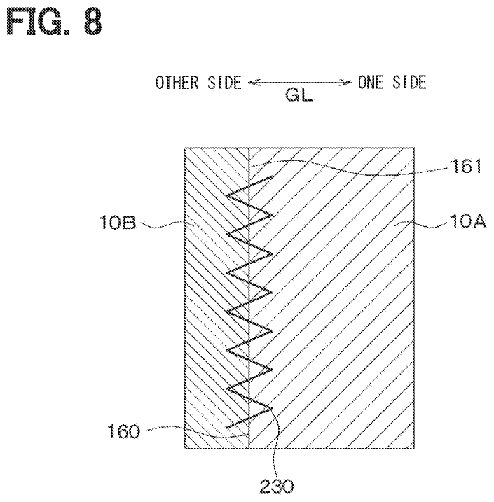

In the first embodiment, there is described the example in which the housing main body 10A and the cover 10B are fixed together by the bolts 120, 121, 122. Alternatively, with reference to FIGS. 7 and 8, there will be described the second embodiment in which the housing main body 10A and the cover 10B are fixed together by welding.

FIG. 7 is a perspective view of the pedal device 1 of the present embodiment, and FIG. 8 is a cross-sectional view taken along line VIII-VIII in FIG. 7.

The housing main body 10A of the present embodiment has a junction surface 160 which faces the other side in the axial direction GL. The junction surface 160 is a first junction surface that is formed around the housing space of the housing main body 10A. The cover 10B has a junction surface 161, which faces the one side in the axial direction GL and serves as a second junction surface.

In the present embodiment constructed in the above-described manner, the housing main body 10A and the cover 10B are fixed together as follows.

The position of the housing main body 10A and the position of the cover 10B are adjusted such that the radial position of the central axis 21 of the bearing 20 and the radial position of the central axis 31 of the bearing 30 coincide with each other. In the state where the position of the housing main body 10A and the position of the cover 10B are adjusted in the above-described manner, the junction surface 160 of the housing main body 10A and the junction surface 161 of the cover 10B are fixed together by, for example, the welding.

The reference sign 230 in FIG. 8 indicates the welding location where the junction surfaces 160, 161 are joined together. In addition to the welding, another joining method, such as fusing, bonding or the like may be used to fix between the junction surface 160 of the housing main body 10A and the junction surface 161 of the cover 10B.

In the manufacturing processes of the present embodiment described above, the position of the housing main body 10A and the position of the cover 10B are adjusted such that the radial position of the central axis 21 of the bearing 20 and the radial position of the central axis 31 of the bearing 30 coincide with each other.

In the state where the position of the housing main body 10A and the position of the cover 10B are adjusted, the housing main body 10A and the cover 10B are fixed together by the welding. Thus, the central axis of the projection 63a of the rotatable shaft 62 and the central axis of the projection 63b of the rotatable shaft 62 can be appropriately positioned. Thus, it is possible to provide the pedal device 1, which allows the pedal 40 to rotate smoothly, and the method for manufacturing the pedal device 1.

### Third Embodiment

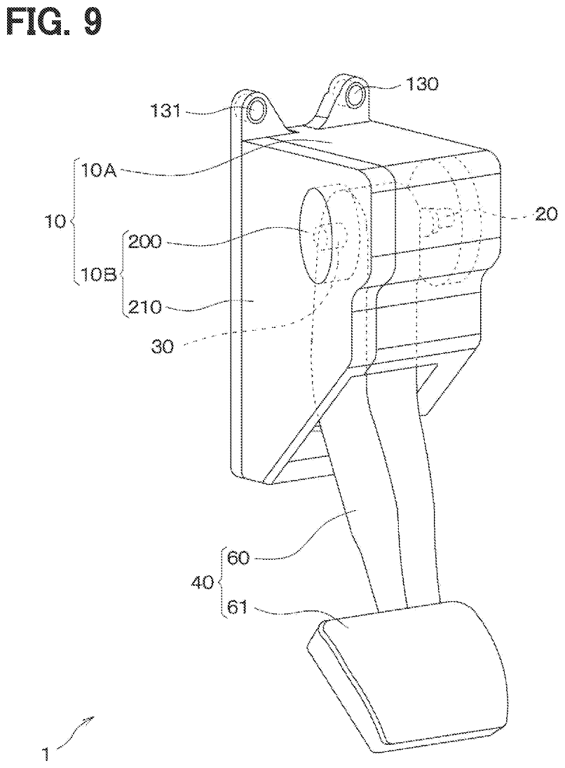

In the third embodiment, with reference to FIGS. 9, 10 and 11, there will be described an example in which the cover 10B in the first embodiment is formed by split cover portions 200, 210.

The configuration of the pedal device 1 of the present embodiment is the same as that of the pedal device 1 of the first embodiment except for the cover 10B. Because of this reason, the cover 10B of the pedal device 1 of the present embodiment will be described.

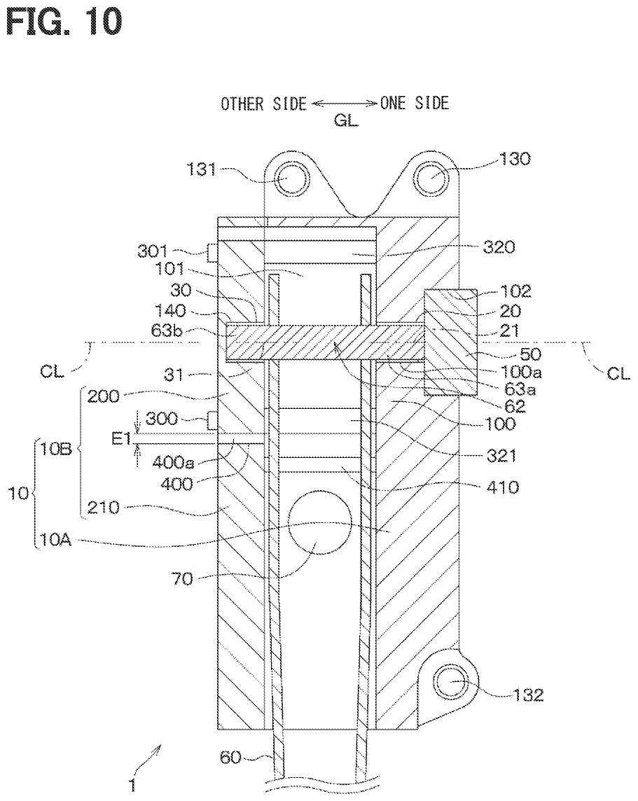

As shown in FIGS. 9 and 10, the cover 10B of the present embodiment includes the split cover portions 200, 210. The split cover portion 200 is a first split cover portion that supports the bearing 20. The split cover portion 200 is placed in a through-hole 400a of the split cover portion 210. The through-hole 400a extends through the split cover portion 210 in the axial direction GL.

As shown in FIG. 10, a clearance (a gap) E1 is formed between a through-hole forming portion 400 of the split cover portion 210, which forms the through-hole 400a, and the split cover portion 200. The clearance E1 is set so as to enable positional adjustment of the split cover portion 200 to coincide the radial position of the central axis 21 of the bearing 20 and the radial position of the central axis 31 of the bearing 30 with each other.

The split cover portion 200 has the recess 140 which opens toward the one side in the axial direction GL.

The bearing 30 is press-fitted into the recess 140 so that the bearing 30 is fixed to the split cover portion 200.

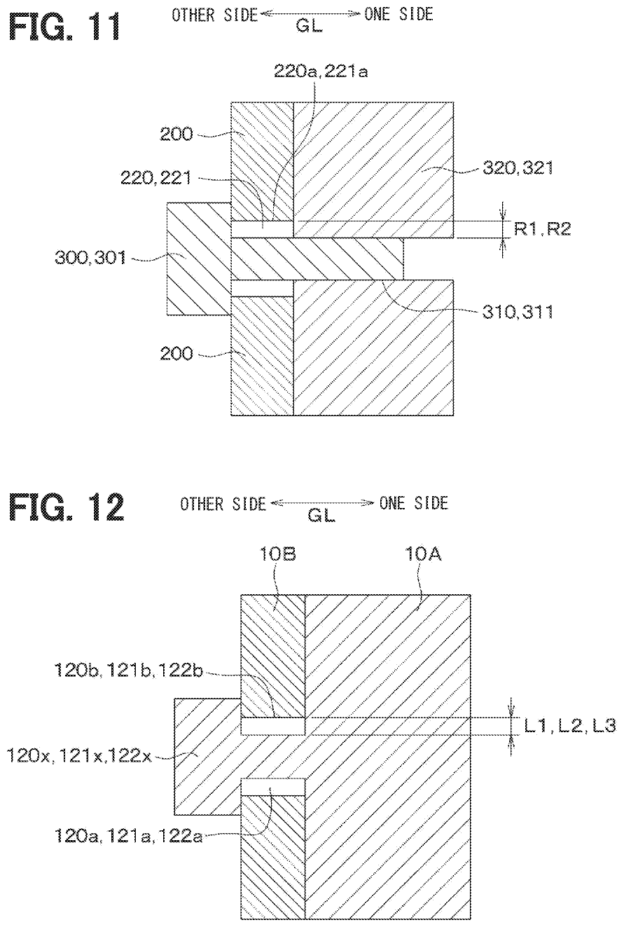

As shown in FIGS. 10 and 11, the split cover portion 200 has through-holes 220, 221, through which the bolts 300, 301 are respectively inserted. The housing main body 10A has threaded holes 310, 311 into which the bolts 300, 301 are respectively inserted and tightened. The threaded holes 310, 311 are formed at support portions 320, 321, respectively, of the housing main body 10A.

Each of the support portions 320, 321 projects from the separation wall 100 toward the other side in the axial direction GL. The threaded hole 310 is formed at a part of the support portion 320 which faces the other side in the axial direction GL. The threaded hole 311 is formed at a part of the support portion 321 which faces the other side in the axial direction GL.

In the present embodiment, in a state where each bolt 300, 301 is inserted through the corresponding through-hole 220, 221 of the split cover portion 200, the bolt 300, 301 is screwed into the corresponding threaded hole 310, 311 and tightened so that the split cover portion 200 is fixed to the housing main body 10A.

In the state where the bolt 300 is inserted through the through-hole 220 of the split cover portion 200, a gap between the through-hole forming portion 220a of the split cover portion 200, which forms the through-hole 220, and the bolt 300 is referred to as a clearance R1.

Furthermore, in the state where the bolt 301 is inserted through the through-hole 221 of the split cover portion 200, a gap between the through-hole forming portion 221a of the split cover portion 200, which forms the through-hole 221, and the bolt 301 is referred to as a clearance R2.

In the present embodiment, the split cover portion 210 and the housing main body 10A are securely fitted together by a labyrinth structure (not shown). The labyrinth structure is a structure in which one of a peripheral portion of the housing and a peripheral portion of the cover is fitted and secured to the other one of the peripheral portion of the housing and the peripheral portion of the cover to limit intrusion of a foreign object into a gap between the housing and the cover.

In the present embodiment, each of the clearances R1, R2 is set so as to enable that the radial position of the central axis 21 of the bearing 20 and the radial position of the central axis 31 of the bearing 30 coincide with each other.

The split cover portion 210 is a second split cover portion that is placed on the radially outer side of the split cover portion 200. Specifically, the split cover portion 210 is formed to cover the split cover portion 200 from the radially outer side of the split cover portion 200.

The split cover portion 210 is fixed to the housing main body 10A by a plurality of snap-fit portions 410. FIG. 10 shows only one of the snap-fit portions 410. The split cover portion 210 is formed to cover the housing main body 10A from the other side in the axial direction GL.

Next, a manufacturing method of the pedal device 1 of the present embodiment will be described with reference to FIG. 6.

First, at the preparation process of step S100 shown in FIG. 6, the housing main body 10A, the split cover portions 200, 210, the bearings 20, 30, the pedal 40 and the rotational angle sensor 50 are separately prepared. In this case, the pedal 40, which is in the state where the rotatable shaft 62 is pre-fixed to the pedal 40, is prepared.

During the assembly process of next step S110, the housing main body 10A, the split cover portions 200, 210, the bearings 20, 30 and the pedal 40 are assembled.

Specifically, the bearing 20 is fixed to the separation wall 100 of the housing main body 10A by press-fitting the bearing 20 into the through-hole 100a of the separation wall 100 of the housing main body 10A.

The projection 63a of the rotatable shaft 62 of the pedal 40 is assembled to the housing main body 10A through the bearing 20 by inserting the projection 63a of the rotatable shaft 62 of the pedal 40 through the bearing 20. In this way, the projection 63a of the rotatable shaft 62 of the pedal 40 is supported by the housing main body 10A through the bearing 20.

Furthermore, the bearing 30 is fixed to the recess 140 of the split cover portion 200 by press-fitting the bearing 30 into the recess 140 of the split cover portion 200. The projection 63b of the rotatable shaft 62 of the pedal 40 is assembled to the split cover portion 200 through the bearing 30 by inserting the projection 63b of the rotatable shaft 62 of the pedal 40 through the bearing 30. In this way, the projection 63b of the rotatable shaft 62 of the pedal 40 is supported by the split cover portion 200 through the bearing 30.

The present disclosure is not limited to the case where the rotatable shaft 62 of the pedal 40 is inserted through the bearing 20 after securely press-fitting the bearing 20 to the housing main body 10A. That is, the bearing 20 may be fixed to the housing main body 10A in a state where the projection 63a of the rotatable shaft 62 of the pedal 40 is inserted through the bearing 20.

Furthermore, the present disclosure is not limited to the case where the projection 63b of the rotatable shaft 62 of the pedal 40 is inserted through the bearing 30 after securely press-fitting the bearing 30 to the split cover portion 200. That is, the bearing 30 may be securely press-fitted to the split cover portion 200 in a state where the projection 63b of the rotatable shaft 62 is inserted through the bearing 30.

Next, at the position adjustment process of step S120, the split cover portion 200 is displaced such that the radial position of the central axis 21 of the bearing 20 and the radial position of the central axis 31 of the bearing 30 coincide with each other.

Therefore, the relative position between the housing main body 10A and the split cover portion 200 is adjusted such that the radial position of the central axis 21 of the bearing 20 and the radial position of the central axis 31 of the bearing 30 coincide with each other.

Specifically, in the state where the bolt 300 is inserted through the through-hole 220 of the split cover portion 200, the bolt 300 is screwed into the threaded hole 310 of the housing main body 10A to a position where the bolt 300 reaches the middle of the threaded hole 310. In the state where the bolt 301 is inserted through the through-hole 221 of the split cover portion 210, the bolt 301 is screwed into the threaded hole 311 of the housing main body 10A to a position where the bolt 301 reaches the middle of the threaded hole 311.

Next, the positional relationship between the rotatable shaft 62 and the housing main body 10A is adjusted such that the distance between the central axis of the rotatable shaft 62 and the housing main body 10A coincides with the predetermined distance. In addition to this, a positional relationship between the rotatable shaft 62 and the split cover portion 200 is adjusted such that a distance between the central axis of the rotatable shaft 62 and the split cover portion 200 coincides with a predetermined distance. Therefore, a positional relationship between the housing main body 10A and the split cover portion 200 is adjusted through the central axis of the rotatable shaft 62.

At this time, a position of each of the bolts 300, 301 is adjusted in the inside of the corresponding one of the through-holes 220, 221 of the split cover portion 200.

Here, the bearing 20 is fixed to the housing main body 10A. The bearing 30 is fixed to the split cover portion 200. Thus, as discussed above, by adjusting the positional relationship between the housing main body 10A and the split cover portion 200 through the central axis of the rotatable shaft 62, the radial position of the central axis 21 of the bearing 20 and the radial position of the central axis 31 of the bearing 30 can coincide with each other.

Next, at the fixation process of step S130, in the state where the bolt 300 is inserted through the through-hole 220 of the split cover portion 200, the bolt 300 is screwed further into the threaded hole 310 of the housing main body 10A until the bolt 300 reaches its final position. In the state where the bolt 301 is inserted through the through-hole 221 of the split cover portion 200, the bolt 301 is screwed further into the threaded hole 311 of the housing main body 10A to a position where the bolt 301 reaches its final position.

Because of this, the housing main body 10A and the split cover portion 200 are fixed together by the bolts 300, 301 in the state where the radial position of the central axis 21 of the bearing 20 and the radial position of the central axis 31 of the bearing 30 coincide with each other. In addition, the split cover portion 210 is securely fitted to the housing main body 10A by the snap-fit portions 410 and the labyrinth structure. Therefore, the split cover portion 200 is placed in the through-hole 400a of the split cover portion 210. Thereby, the manufacturing of the pedal device 1 ends.

According to the present embodiment described above, the cover 10B of the pedal device 1 includes: the split cover portion 200, which supports the bearing 30; and the split cover portion 210 which is placed on the radially outer side of the split cover portion 200. The split cover portion 210 is formed to cover the housing main body 10A from the other side in the axial direction GL.

The position of the housing main body 10A and the position of the split cover portion 200 are adjusted such that the radial position of the central axis 21 of the bearing 20 and the radial position of the central axis 31 of the bearing 30 coincide with each other. In the state where the position of the housing main body 10A and the position of the split cover portion 200 are adjusted, the housing main body 10A and the split cover portion 200 are fixed together by the bolts 300, 301.

Thereby, the central axis 21 of the bearing 20 and the central axis 31 of the bearing 30 can coincide with each other. Thus, the central axis of the projection 63a of the rotatable shaft 62 and the central axis of the projection 63b of the rotatable shaft 62 can be appropriately positioned. Thus, it is possible to provide the pedal device 1, which allows the pedal 40 to rotate smoothly, and the method for manufacturing the pedal device 1.

In the present embodiment, the split cover portion 200 is fixed to the housing main body 10A by the bolts 300, 301. Therefore, the portion of the cover 10B, which is adjacent to the bearing 30, can be fixed to the housing main body 10A by the bolts 300, 301. Thus, the rotational accuracy and the strength of the bearing 30 can be ensured.

In the present embodiment, the cover 10B is formed by the split cover portions 200, 210, and thereby the split cover portion 210 and the housing main body 10A can be fixed together by simple fastener members such as the snap-fit portions 410. Furthermore, the labyrinth structure is used to fit between the split cover portion 210 and the housing main body 10A, and thereby it is possible to limit the intrusion of the foreign object into the gap between the split cover portion 210 and the housing main body 10A.

### Fourth Embodiment

In the first and second embodiments, there is described the example in which the housing main body 10A and the cover 10B are fixed together by the bolts 120, 121, 122.

Alternatively, with reference to FIG. 12, there will be described the fourth embodiment in which the housing main body 10A and the cover 10B are fixed together by heat staking.

In the present embodiment, fastener members 120x, 121x, 122x are used instead of the bolts 120, 121, 122. Each of the fastener members 120x, 121x, 122x is an integral component that is formed integrally in one-piece with the housing main body 10A, as shown in FIG. 12. In a state where each of the fastener members 120x, 121x, 122x is inserted through a corresponding one of the through-holes 120a, 121a, 122a of the cover 10B, a distal end portion of each of the fastener members 120x, 121x, 122x is heat staked against the cover 10B so that the housing main body 10A and the cover 10B are fixed together. The housing main body 10A, the cover 10B and the fastener members 120x, 121x, 122x are respectively made of a resin material.

### OTHER EMBODIMENTS

(1) In the first, second, third and fourth embodiments described above, there is described the example in which the pedal device 1 is installed on the automobile 80 which serves as the vehicle. However, the present disclosure is not limited to this. The pedal device 1 may be installed on another type of vehicle, such as a fueled train, or an electric train. The pedal device 1 may be installed on a mobile vehicle such as a manned drone, a helicopter, an airplane, etc. Alternatively, the pedal device 1 may be installed on various industrial equipment such as a competitive equipment used in an e-sport, a gaming device, or a machine tool.

(2) In the first, second, third and fourth embodiments described above, there is described the example in which the pedal device 1 is installed as the brake pedal device on the automobile 80. However, the present disclosure is not limited to this. The pedal device 1 may be installed as an accelerator pedal device on the automobile 80. Also, the pedal device 1 may be installed as a clutch pedal device on the automobile 80.

(3) In the first, second, third and fourth embodiments described above, there is described the example in which the pedal device 1 is installed on the wall 801, which is the upright wall, of the vehicle body. However, the present disclosure is not limited to this. The pedal device 1 may be installed on a floor or a dash panel in the vehicle cabin.

(4) In the fourth embodiment described above, there is described the example in which the housing main body 10A and the cover 10B are fixed together by the heat staking using the fastener members 120x, 121x, 122x integrally formed with the housing main body 10A in one-piece.

Alternatively, the housing main body 10A and the split cover portion 200 may be fixed together by heat staking using the fastener members 120x, 121x, 122x which are formed separately from the housing main body 10A.

(5) In the fourth embodiment described above, there is described the example in which the housing main body 10A and the split cover portion 200 are fixed together by the heat staking of the fastener members 120x, 121x, 122x.

However, the housing main body 10A and the split cover portion 200 may be fixed together by mechanical staking which mechanically and plastically deform the fastener members 120x, 121x, 122x.

(6) In the first, second, third and fourth embodiments described above, there is described the example in which the plain bearings are used as the bearings 20, 30, respectively. Alternatively, ball bearings, roller bearings, magnetic bearings, fluid dynamic bearings, etc. may be used as the bearings 20, 30, respectively.

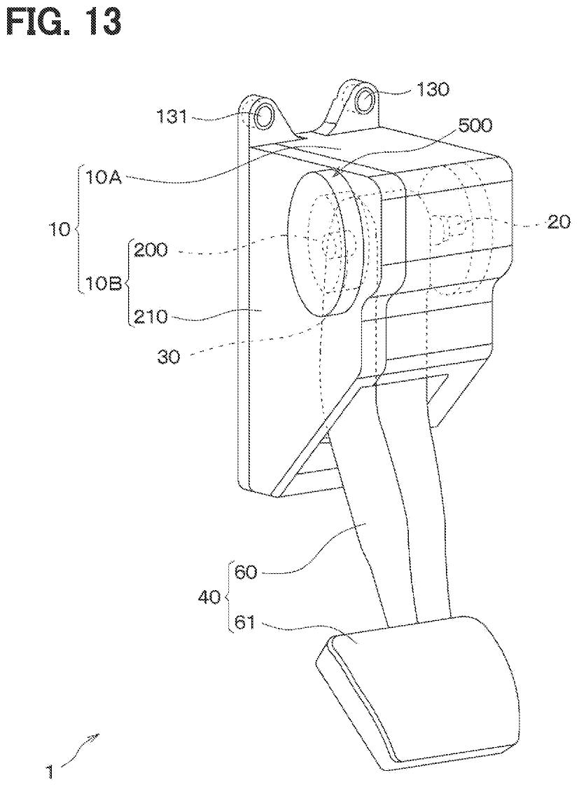

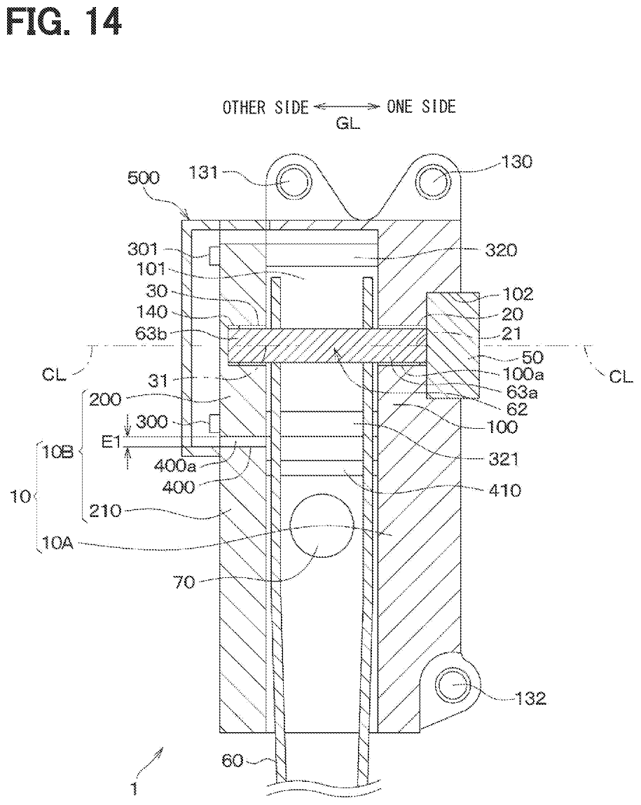

(7) In the third embodiment described above, the split cover portions 200, 210 are used to form the cover 10B. However, in addition to this, as shown in FIGS. 13 and 14, a cover member 500, which covers the split cover portion 200 and the through-hole 400a of the split cover portion 210 from the other side in the axial direction GL, may be added.

FIG. 13 is a perspective view of the pedal device according to the other embodiment. FIG. 14 is a cross-sectional view of the pedal device of FIG. 13 taken along a plane that is parallel to the up-down direction of the vehicle and includes the pedal central axis.

Thereby, it is possible to limit intrusion of a foreign object into the housing space 101 of the housing main body 10A through the through-hole 400a (i.e., the gap between the through-hole forming portion 400 and the split cover portion 200). In this case, the cover member 500 may be an integrated component in which the cover member 500 is integrated together with the split cover portion 210 in one-piece.

(8) In the third embodiment described above, there is described the example in which the split cover portion 200 and the housing main body 10A are fixed together by the bolts 300, 301. Alternatively, the split cover portion 200 and the housing main body 10A may be fixed together by using a joining method, such as welding, fusing or bonding.

(9) In the first, second, third and fourth embodiments described above, there is described the example in which the projection 63a of the rotatable shaft 62 projects from the pedal arm 60 toward the housing main body 10A. Alternatively, as discussed in the following sections (a) and (b), the projection 63a may be formed to project from the housing main body 10A toward the pedal arm 60. In this case, the projection 63b is formed to project from the pedal arm 60 toward the cover 10B.

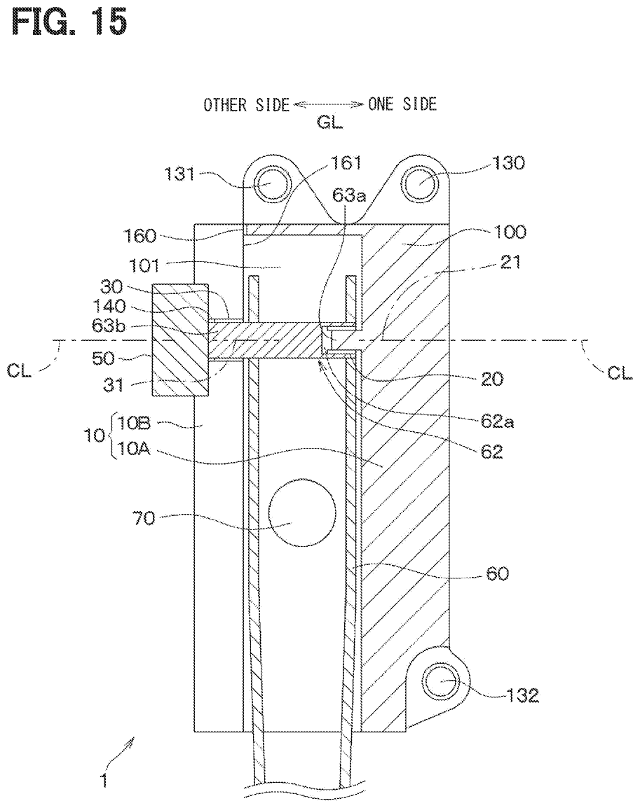

(a) As shown in FIG. 15, a distal end portion of the projection 63a is inserted into a recess 62a of the rotatable shaft 62. The recess 62a is recessed at the rotatable shaft 62 from the one side toward the other side in the axial direction GL. In this case, the bearing 20 is placed in the inside of the recess 62a of the rotatable shaft 62. The bearing 20 is supported by an inner peripheral surface of the recess 62a of the rotatable shaft 62. The rotational angle sensor 50 is supported by the cover 10B.

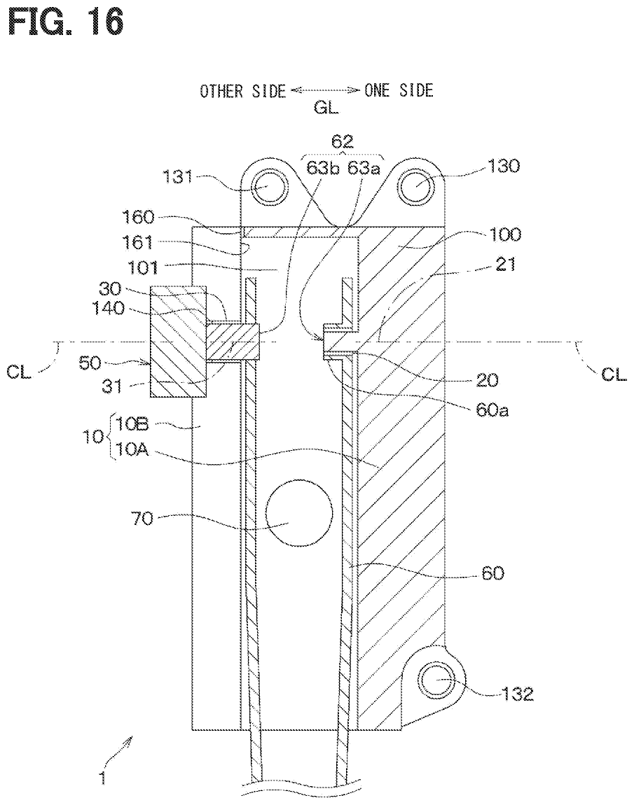

(b) As shown in FIG. 16, the projection 63a and the projection 63b are separated from each other. A distal end portion of the projection 63a is inserted into a cylindrical tubular portion 60a of the pedal arm 60. The cylindrical tubular portion 60a is shaped in a cylindrical tubular form and is centered on the swing center CL. The cylindrical tubular portion 60a is formed to project from an axial end portion of the pedal arm 60, which faces the one side in the axial direction GL, toward the other side in the axial direction GL. In this case, the bearing 20 is supported by an inner peripheral surface of the cylindrical tubular portion 60a of the pedal arm 60.

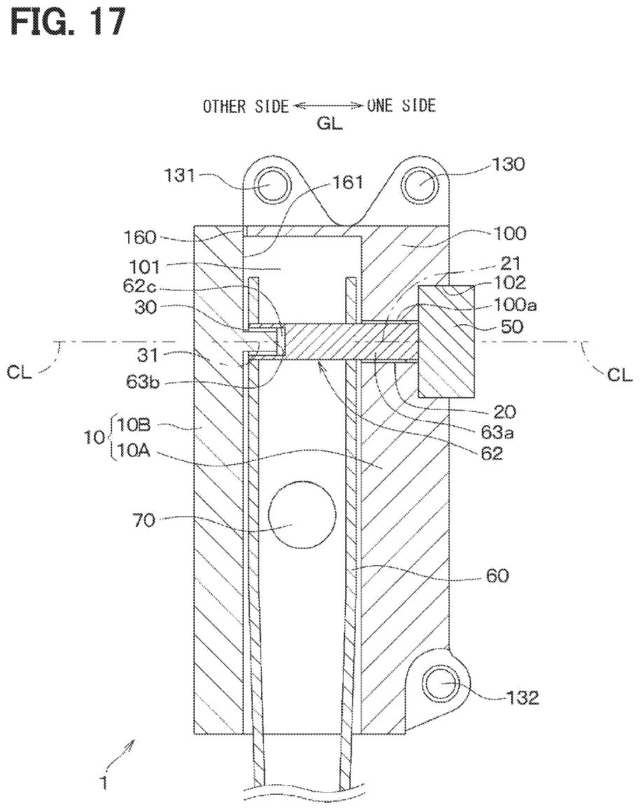

(10) In the first, second, third and fourth embodiments described above, there is described the example in which the projection 63b of the rotatable shaft 62 projects from the pedal arm 60 toward the cover 10B. Alternatively, as shown in FIG. 17 and described in the following sections (c) and (d), the projection 63b may be formed to project from the cover 10B toward the pedal arm 60. In this case, the projection 63a is formed to project from the pedal arm 60 toward the housing main body 10A.

(c) As shown in FIG. 17, a distal end portion of the projection 63b is inserted into a recess 62c of the rotatable shaft 62. The recess 62c is recessed at the rotatable shaft 62 from the other side toward the one side in the axial direction GL. In this case, the bearing 30 is placed in the inside of the recess 62c of the rotatable shaft 62. The bearing 30 is supported by an inner peripheral surface of the recess 62c of the rotatable shaft 62.

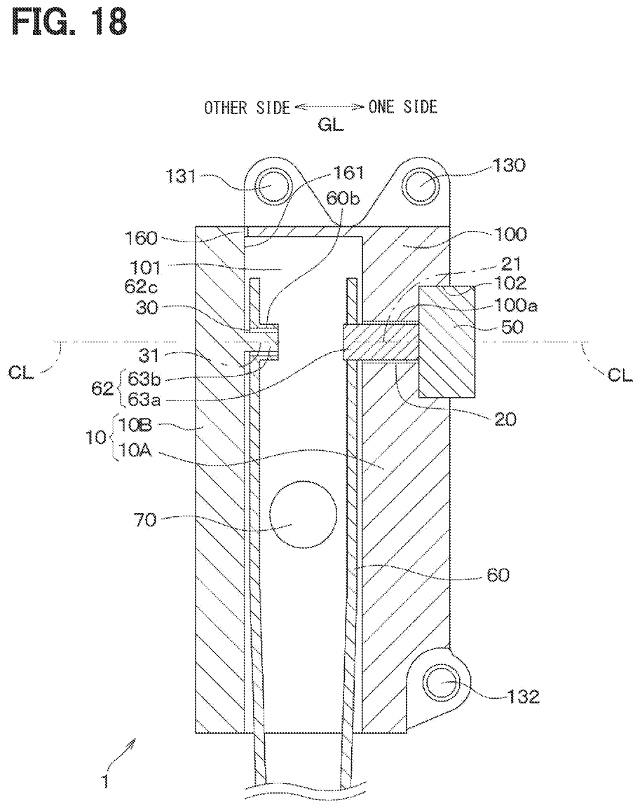

(d) As shown in FIG. 18, the projection 63a and the projection 63b are separated from each other. A distal end portion of the projection 63b is inserted into a cylindrical tubular portion 60b of the pedal arm 60. The cylindrical tubular portion 60b is shaped in a cylindrical tubular form and is centered on the swing center CL. The cylindrical tubular portion 60b is formed to project from an axial end portion of the pedal arm 60, which faces the other side in the axial direction GL, toward the one side in the axial direction GL. In this case, the bearing 30 is supported by an inner peripheral surface of the cylindrical tubular portion 60b of the pedal arm 60.

(11) The present disclosure is not limited to the above embodiments, and the above embodiments may be appropriately modified. Further, the above embodiments are not unrelated to each other and can be appropriately combined unless the combination is clearly impossible. Needless to say, in each of the above-described embodiments, the elements of the embodiment are not necessarily essential except when it is clearly indicated that they are essential and when they are clearly considered to be essential in principle. In each of the above embodiments, when a numerical value such as the number, numerical value, amount, range or the like of the constituent elements of the embodiment is mentioned, the present disclosure should not be limited to such a numerical value unless it is clearly stated that it is essential and/or it is required in principle. In each of the above embodiments, when the shape, the positional relationship or the like of the constituent elements of the embodiment are mentioned, the present disclosure should not be limited the shape, the positional relationship or the like unless it is clearly stated that it is essential and/or it is required in principle.

### Characteristics of Present Disclosure

According to disclosure 1, there is provided a pedal device including:
a pedal that is configured to be depressed by an operator;
a rotatable shaft that has a central axis;
a housing that includes a cover and a housing main body, wherein the housing main body is placed on one side relative to the cover in an axial direction that is an extending direction of the central axis;
a first bearing; and
a second bearing, wherein:
the rotatable shaft includes:
   a first projection that projects from one of the pedal and the housing main body toward another one of the pedal and the housing main body; and
   a second projection that projects from one of the pedal and the cover toward another one of the pedal and the cover, wherein the first projection and the second projection extend in the axial direction;
the first bearing is supported by the another one of the pedal and the housing main body and rotatably supports the first projection of the rotatable shaft;
the second bearing is supported by the another one of the pedal and the cover and rotatably supports the second projection of the rotatable shaft;
the pedal is supported by the rotatable shaft to enable rotation of the pedal relative to the housing; and
the cover and the housing main body are fixed relative to each other in an adjusted state where a position of the cover and a position of the housing main body are adjusted such that a radial position of a central axis of the first bearing in a radial direction and a radial position of a central axis of the second bearing in the radial direction coincide with each other, wherein the radial direction is a direction perpendicular to the central axis.

According to disclosure 2, there is provided the pedal device according to disclosure 1, including a fastener component that fixes between the housing main body and the cover, wherein:
the cover has a through-hole forming portion that forms a through-hole, wherein the through-hole extends through the cover in the axial direction; and
a clearance, which is a gap between the fastener component and the through-hole forming portion, is set so as to enable that the radial position of the central axis of the first bearing and the radial position of the central axis of the second bearing coincide with each other.

According to disclosure 3, there is provided the pedal device according to disclosure 1 or 2, wherein:
the cover includes:
   a first split cover portion that supports the second bearing; and
   a second split cover portion that covers the housing main body from another side, which is opposite to the one side, in the axial direction; and
the first split cover portion and the housing main body are fixed relative to each other in an adjusted state where a position of the first split cover portion and the position of the housing main body are adjusted such that the radial position of the central axis of the first bearing and the radial position of the central axis of the second bearing coincide with each other.

According to disclosure 4, there is provided a method for manufacturing a pedal device that includes:
a pedal that is configured to be depressed by an operator;
a rotatable shaft that has a central axis;
a housing that includes a cover and a housing main body, wherein the housing main body is placed on one side relative to the cover in an axial direction that is an extending direction of the central axis;
a first bearing; and
a second bearing, wherein:
the rotatable shaft includes:
   a first projection that projects from one of the pedal and the housing main body toward another one of the pedal and the housing main body; and
   a second projection that projects from one of the pedal and the cover toward another one of the pedal and the cover, wherein the first projection and the second projection extend in the axial direction;
the first bearing is supported by the another one of the pedal and the housing main body and rotatably supports the first projection of the rotatable shaft;
the second bearing is supported by the another one of the pedal and the cover and rotatably supports the second projection of the rotatable shaft;
the pedal is supported by the rotatable shaft to enable rotation of the pedal relative to the housing, the method including:
assembling the pedal and the housing main body through the first bearing in a manner that implements a state where the first projection is supported by the first bearing;
assembling the pedal and the cover through the second bearing in a manner that implements a state where the second projection is supported by the second bearing;
adjusting a position of the housing main body and a position of the cover such that a radial position of a central axis of the first bearing in a radial direction and a radial position of a central axis of the second bearing in the radial direction coincide with each other, wherein the radial direction is a direction perpendicular to the central axis; and fixing the housing main body and the cover relative to each other in an adjusted state where the position of the housing main body and the position of the cover are adjusted.

According to disclosure 5, there is provided the method for manufacturing the pedal device according to disclosure 4, wherein:
the cover has a through-hole that extends through the cover in the axial direction; and
the fixing of the housing main body and the cover relative to each other in the adjusted state where the position of the housing main body and the position of the cover are adjusted includes fixing the housing main body and the cover by a fastener component in a state where the fastener component extends through the through-hole.

According to disclosure 6, there is provided the method for manufacturing the pedal device according to disclosure 5, wherein the adjusting of the position of the housing main body and the position of the cover includes adjusting the position of the housing main body and the position of the cover by displacing the fastener component in the through-hole.

According to disclosure 7, there is provided the method for manufacturing the pedal device according to disclosure 4, wherein:
the housing main body has a first junction surface that faces another side, which is opposite to the one side, in the axial direction;
the cover has a second junction surface that faces the one side in the axial direction; and
the fixing of the housing main body and the cover relative to each other includes fixing the housing main body and the cover relative to each other by joining the first junction surface of the housing main body and the second junction surface of the cover together.

According to disclosure 8, there is provided the method for manufacturing the pedal device according to disclosure 4, wherein:
the cover includes:
   a first split cover portion that supports the second bearing; and
   a second split cover portion that covers the housing main body from another side, which is opposite to the one side, in the axial direction; and
the adjusting of the position of the housing main body and the position of the cover includes adjusting the position of the housing main body and a position of the first split cover portion such that a position of the central axis of the first bearing and a position of the central axis of the second bearing coincide with each other.

What is claimed is:

1. A pedal device comprising:
a pedal that is configured to be depressed by an operator;
a rotatable shaft that has a central axis;
a housing that includes a cover and a housing main body, wherein the housing main body is placed on one side relative to the cover in an axial direction that is an extending direction of the central axis;
a first bearing;
a second bearing; and
a sensor that is configured to sense a rotational angle of the rotatable shaft, wherein:
the rotatable shaft includes:
a first projection that projects from one of the pedal and the housing main body toward another one of the pedal and the housing main body; and
a second projection that projects from one of the pedal and the cover toward another one of the pedal and the cover, wherein the first projection and the second projection extend in the axial direction;
the first bearing is supported by the another one of the pedal and the housing main body and rotatably supports the first projection of the rotatable shaft;
the second bearing is supported by the another one of the pedal and the cover and rotatably supports the second projection of the rotatable shaft;
the pedal is supported by the rotatable shaft to enable rotation of the pedal relative to the housing; and
the cover and the housing main body are fixed relative to each other in an adjusted state where a position of the cover and a position of the housing main body are adjusted such that a radial position of a central axis of the first bearing in a radial direction and a radial position of a central axis of the second bearing in the radial direction coincide with each other, wherein the radial direction is a direction perpendicular to the central axis.

2. The pedal device according to claim 1, comprising a fastener component that fixes between the housing main body and the cover, wherein:
the cover has a through-hole forming portion that forms a through-hole, wherein the through-hole extends through the cover in the axial direction; and
a clearance, which is a gap between the fastener component and the through-hole forming portion, is set so as to enable that the radial position of the central axis of the first bearing and the radial position of the central axis of the second bearing coincide with each other.

3. The pedal device according to claim 1, wherein:
the cover includes:
a first split cover portion that supports the second bearing; and
a second split cover portion that covers the housing main body from another side, which is opposite to the one side, in the axial direction; and
the first split cover portion and the housing main body are fixed relative to each other in an adjusted state where a position of the first split cover portion and the position of the housing main body are adjusted such that the radial position of the central axis of the first bearing and the radial position of the central axis of the second bearing coincide with each other.

4. A method for manufacturing a pedal device that includes:
a pedal that is configured to be depressed by an operator;
a rotatable shaft that has a central axis;
a housing that includes a cover and a housing main body, wherein the housing main body is placed on one side relative to the cover in an axial direction that is an extending direction of the central axis;
a first bearing;
a second bearing; and
a sensor that is configured to sense a rotational angle of the rotatable shaft, wherein:
the rotatable shaft includes:
a first projection that projects from one of the pedal and the housing main body toward another one of the pedal and the housing main body; and
a second projection that projects from one of the pedal and the cover toward another one of the pedal and the cover, wherein the first projection and the second projection extend in the axial direction;
the first bearing is supported by the another one of the pedal and the housing main body and rotatably supports the first projection of the rotatable shaft;
the second bearing is supported by the another one of the pedal and the cover and rotatably supports the second projection of the rotatable shaft;
the pedal is supported by the rotatable shaft to enable rotation of the pedal relative to the housing, the method comprising:
assembling the pedal and the housing main body through the first bearing in a manner that implements a state where the first projection is supported by the first bearing;
assembling the pedal and the cover through the second bearing in a manner that implements a state where the second projection is supported by the second bearing;
adjusting a position of the housing main body and a position of the cover such that a radial position of a central axis of the first bearing in a radial direction and a radial position of a central axis of the second bearing in the radial direction coincide with each other, wherein the radial direction is a direction perpendicular to the central axis; and
fixing the housing main body and the cover relative to each other in an adjusted state where the position of the housing main body and the position of the cover are adjusted.

5. The method for manufacturing the pedal device according to claim 4, wherein:
the cover has a through-hole that extends through the cover in the axial direction; and
the fixing of the housing main body and the cover relative to each other in the adjusted state where the position of the housing main body and the position of the cover are adjusted includes fixing the housing main body and the cover by a fastener component in a state where the fastener component extends through the through-hole.

6. The method for manufacturing the pedal device according to claim 5, wherein the adjusting of the position of the housing main body and the position of the cover includes adjusting the position of the housing main body and the position of the cover by displacing the fastener component in the through-hole.

7. The method for manufacturing the pedal device according to claim 4, wherein:
the housing main body has a first junction surface that faces another side, which is opposite to the one side, in the axial direction;
the cover has a second junction surface that faces the one side in the axial direction; and
the fixing of the housing main body and the cover relative to each other includes fixing the housing main body and the cover relative to each other by joining the first junction surface of the housing main body and the second junction surface of the cover together.

8. The method for manufacturing the pedal device according to claim 4, wherein:
the cover includes:
a first split cover portion that supports the second bearing; and
a second split cover portion that covers the housing main body from another side, which is opposite to the one side, in the axial direction; and
the adjusting of the position of the housing main body and the position of the cover includes adjusting the position of the housing main body and a position of the first split cover portion such that a position of the central axis of the first bearing and a position of the central axis of the second bearing coincide with each other.
